(19) United States
(12) Patent Application Publication
(10) Pub. No.: US 2005/0289334 A1
(43) Pub. Date: Dec. 29, 2005

(54) Method for loading multiprocessor program

(75) Inventors: Tomohiro Yamana, Nagasaki (JP); Teruhiko Kamigata, Kawasaki (JP); Hideo Miyake, Kawasaki (JP); Atsuhiro Suga, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 11/135,659

(22) Filed: May 24, 2005

Related U.S. Application Data
(63) Continuation of application No. PCT/JP03/05806, filed on May 9, 2003.

(51) Int. Cl. G06F 15/177

(52) U.S. Cl. 713/1

(57) ABSTRACT

In a computer system having a plurality of processing elements (PE#0 to PE#n) and adopting a distributed-shared-memory-type multiprocessor scheme, a master PE (for example, PE#0) executing a multi PE loader transfers an MPMD program for PE#k to a predetermined area of memory space of PE#0 to which a unique memory (LM) of PE#k is temporally allocated. The LMs of PE#1 to PE#n can be allocated to different areas of the memory space of PE#0 respectively, or can be allocated the same area thereof.

### BACKGROUND OF THE INVENTION

1) Field of the Invention

The present invention relates to a method for loading a Multiple-Processor Multiple-Data program to each of a plurality of processing elements.

2) Description of the Related Art

Recently, some computer systems include a plurality of processors and adopt a distributed-memory multiprocessors scheme to improve the processing performance (for example, see Japanese Patent Application Laid-Open Publication No. S56-40935 or No. H7-64938).

FIG. 1 is a schematic diagram of a computer system adopting the distributed-memory multiprocessor scheme. N processing elements (hereinafter, “PE”) 100 each including a processor 101 and a memory 102 are connected to one another by an interconnection network 103.

FIG. 2 is a definition of memory space in the computer system. Each processor 101 performs reading and writing only on the memory 102 in the same PE 100.

In such a system, a Single-Program Multiple-Data (SPMD) program is often executed by means of an inter-processor communication mechanism, such as a Message-Passing Interface (MPI).

FIG. 3 is an example of the SPMD program. The SPMD program is stored in each of the N memories 102, and is executed by each of the N processors 101. Although the SPMD programs in the memories 102 are identical, the process is branched depending on an identification number (hereinafter, “ID”) of the PE 100, thereby achieving concurrent processing by the N PEs 100.

For example, in the program shown in FIG. 3, “my_rank” is a variable indicative of the ID. In the PEs other than the PE whose ID is 0 (my_rank=0), a process following the if clause is executed. In the PE whose ID is 0 (my_rank=0), a process following the else statement is executed.

In the above scheme, however, each PE has to include a memory with a sufficient capacity to store the entire program because each PE is allocated the entire program in spite of the fact that it executes only a part of the program (hereinafter “a partial program”). Therefore, an increase in cost cannot be avoided.

By the way, a system adopting the above scheme conventionally includes a plurality of chips (or a plurality of boards) due to limitations of semiconductor integration technology. However, with recent improved semiconductor integration technology, a plurality of PEs can be accommodated in one chip.

In this case, data exchange among the PEs via an interconnection network can be performed at a higher speed by directly reading/writing data from/in a shared memory. A scheme with a shared memory readable and writable from a plurality of processors is called “a distributed-shared-memory multiprocessor scheme”.

FIG. 4 is a schematic diagram of a computer system adopting the distributed-shared-memory multiprocessor scheme. A PE 400, a processor 401, and an interconnection network 403 are identical to the PE 100, the processor 101, and the interconnection network 103. A difference is that a memory 402 includes (1) a shared memory (hereinafter, “SM”) readable and writable from processors in other PEs and (2) a local memory (hereinafter, “LM”) readable and writable only from a processor in the same PE.

FIG. 5 is a definition of memory space in the computer system. For example, the SM of a first PE (hereinafter, “PE#1”) is redundantly allocated to memory space of a 0-th PE (hereinafter, “PE#0”) as well as that of the PE#1 itself.

It is assumed that the SM of PE#1 is allocated to an address of 0×3000 or lower in the memory space of PE#0 and to an address of 0×2000 or lower in the memory space of PE#1. For example, PE#0 writes data at 0×3000 and PE#1 reads data from 0×2000 to exchange the data between PE#0 and PE#1.

Here, only PE#0 can read and write the SMs of all of the other PEs. On the other hand, each of the PEs can only read and write the SM and the LM within the same PE allocated to memory space thereof.

In such a computer system, a Multiple-Programming Multiple-Data (MPMD) program can solve the above cost problem.

The MPMD program, unlike the SPMD program including all partial programs, includes a plurality of program each of which is dedicated to each PE. Each program for each PE does not include a partial program for other PEs, thereby reducing the capacity of the memory.

FIG. 6 is an example of the MPMD program that causes PE#0 to send a request for a predetermined process to PE#1 and receive the result of the process from the PE#1. FIG. 7 is an example of the MPMD program that causes PE#1 to execute the process.

A function Th0 shown FIG. 6 causes PE#0 to set the value of a variable “input” in a variable “in” (Th0-1 in FIG. 6), and then instruct PE#1 to execute a function Th1 (Th0-2 in FIG. 6). Upon receiving the instruction, PE#1 executes the function Th1 to call the function f1 with the variable “in” as an argument, and to set the execution result of the function f1 in a variable “out” (Th1-1 in FIG. 7). Thereafter, PE#0 sets the value of the variable “out” in a variable “output” (Th0-3 in FIG. 6).

After requesting PE#1 to perform the process (that is, after Th0-2), PE#0 performs another process unrelated to PE#1. Here, for convenience of description, only a cooperative portion between PE#0 and PE#1 is shown.

The applicant has already filed a patent application for an invention regarding the creation of a load module of such a program as shown in FIGS. 6 and 7 (for example, refer to Japanese Patent Application Laid-Open Publication No. 2002-238399).

In the computer system adopting the distributed-shared-memory multiprocessor scheme, a piece of data can have a plurality of addresses for each PE. Therefore, a linker according to the above invention converts, for example, an address of the variable “in” in the MPMD program for PE#0 to “0×3000”, whereas converting the same variable “in” in the MPMD program for PE#1 to “0×2000”, thereby creating a load module executable by each PE.

However, conventionally, a multi PE loader for efficiently distributing the load module created according to the invention has not been present.

That is, since the conventional loader is targeted for the SMPD program, the loader only transfers the load module in the ROM 404 to the memory 402 within the PE that executes the loader. Therefore, when there is a plurality of PEs, each PE has to execute its loader. In this case, since different programs are loaded by different PEs, a different loader is required for each PE.

### SUMMARY OF THE INVENTION

It is an object of the present invention to at least solve the problems in the conventional technology.

A method according to an aspect of the present invention is a method for loading a multiple processor multiple data (MPMD) program to a computer system. The computer system includes a first processing element (PE) and a plurality of second PEs, and the first PE and the second PEs respectively include a memory. The method includes allocating the memory of each second PE to memory space of the first PE; and transferring the MPMD program from the memory of the first PE to the memory of each second PE that is allocated to the memory space.

A computer-readable recording medium according to another aspect of the present invention stores a loader program that causes a computer system to execute the above method.

A computer system according to still another aspect of the present invention includes a first processing element (PE) and a plurality of second PEs. The first PE and the second PEs respectively include a memory. The first PE includes an allocating unit that allocates the memory of each second PE to memory space of the first PE; and a transferring unit that transfers the MPMD program to the memory of each second PE that is allocated to the memory space.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of a computer system adopting a distributed-memory multiprocessor scheme;

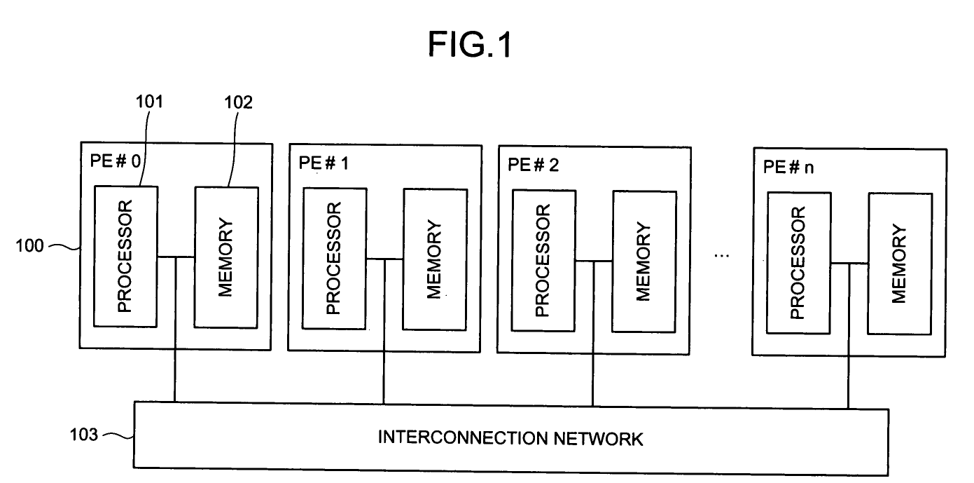

FIG. 2 is a definition of memory space in the computer system;

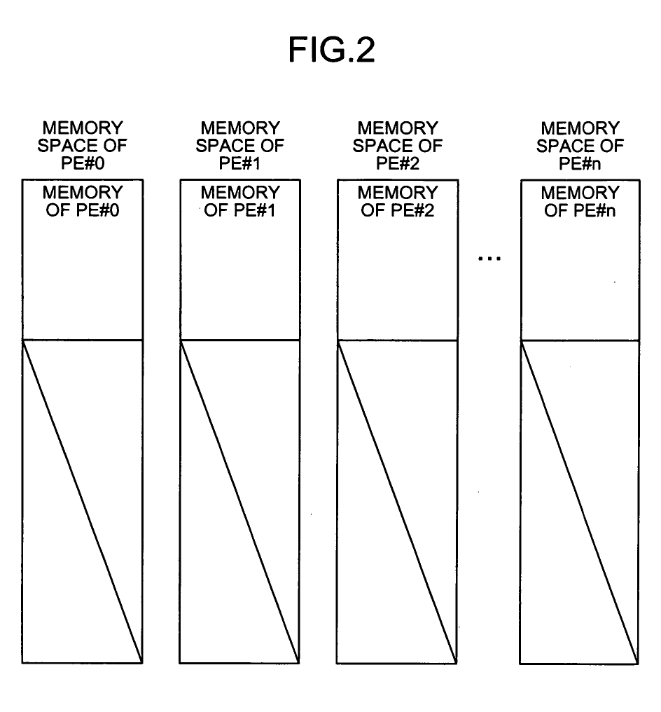

FIG. 3 is an example of a Single-Program Multiple-Data program;

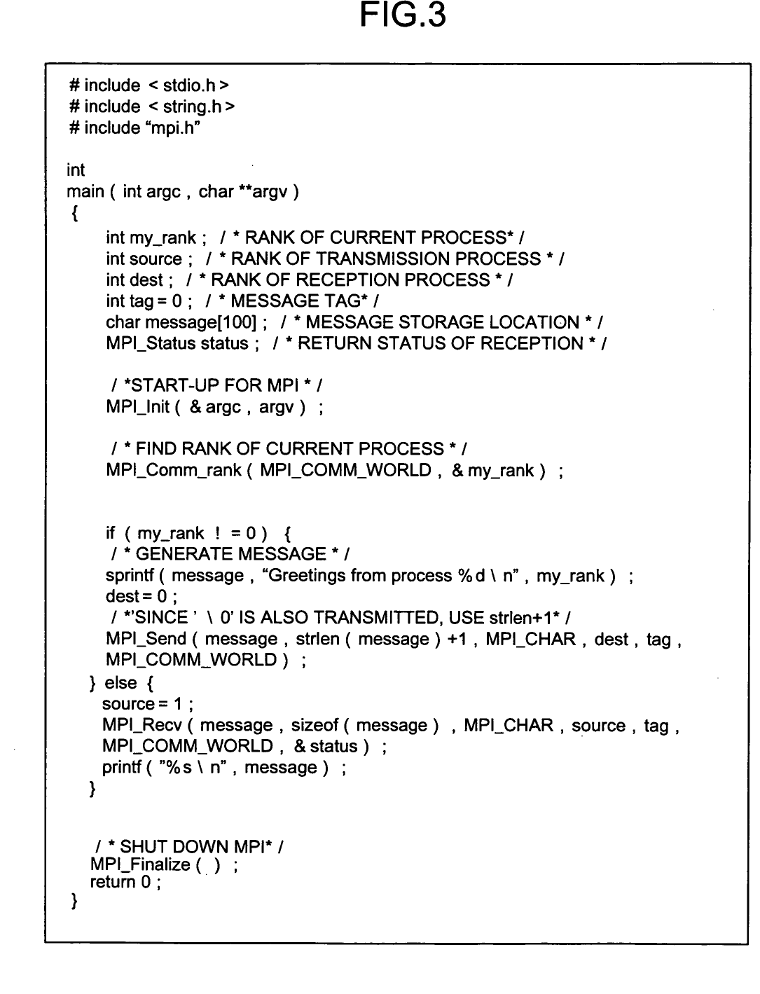

FIG. 4 is a schematic diagram of a computer system adopting a distributed-shared-memory multiprocessor scheme;

FIG. 5 is a definition of memory space of the computer system;

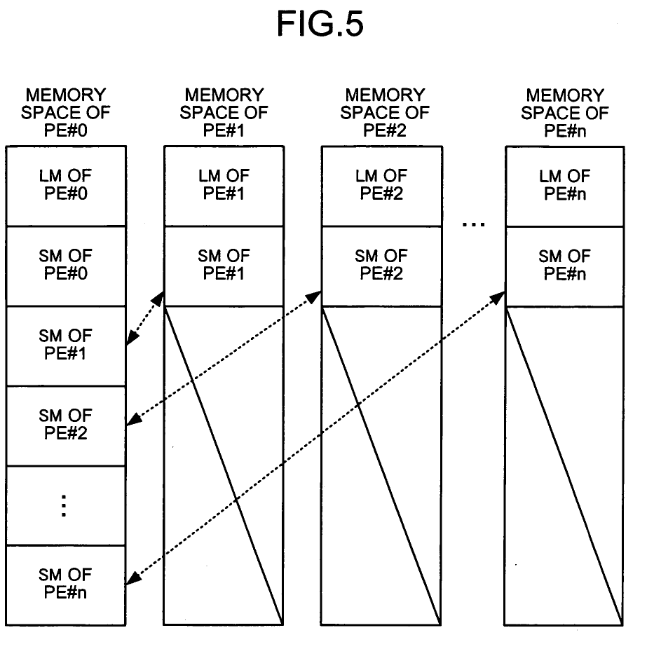

FIG. 6 is an example of a Multiple-Program Multiple-Data (MPMD) program for PE#0;

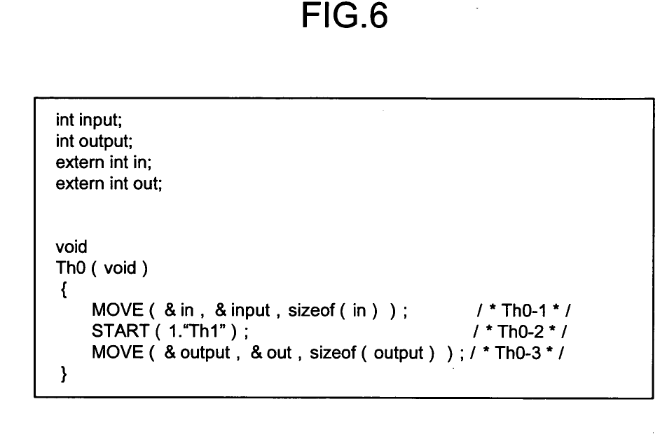

FIG. 7 is an example of an MPMD program for PE#1;

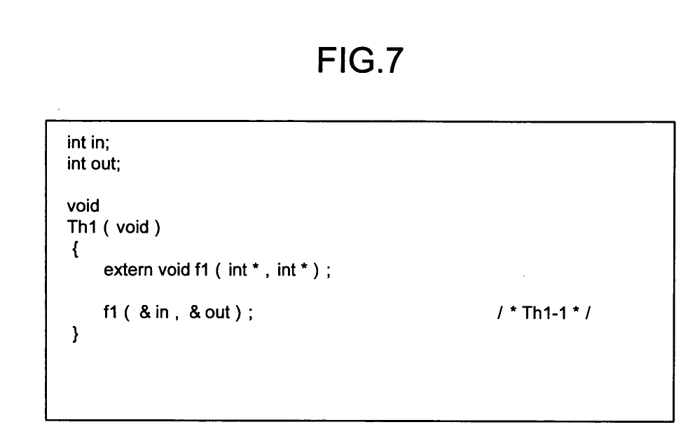

FIG. 8 is a schematic diagram of memory space before a conventional loader is executed;

FIG. 9 is a schematic diagram of the memory space after the conventional loader is executed;

FIG. 10 is a schematic diagram of memory spaces before a loader according to the present invention is executed;

FIG. 11 is a schematic diagram of the memory spaces after the loader according to the present invention is executed;

FIG. 12 is a functional block diagram of a computer system according to a first embodiment of the present invention;

FIG. 13 is a schematic diagram for explaining allocation of unique memories (LMs) of PE#1 to PE#n to memory space of PE#0 according to the first embodiment;

FIG. 14 is a flowchart of a program loading/executing process performed by the computer system;

FIG. 15 is a flowchart of a program loading/executing process performed by a computer system according to a second embodiment of the present invention;

FIG. 16 is a schematic diagram for explaining allocation of LMs of PE#1 to PE#n to memory space of PE#0 according to the second embodiment;

FIG. 17 is a functional diagram of a computer system according to a third embodiment of the present invention;

FIG. 18 is a flowchart of a program loading/executing process performed by the computer system; and

FIG. 19 is a schematic diagram for explaining a program transfer route according to the third embodiment.

### DETAILED DESCRIPTION

Exemplary embodiments of the present invention will be explained in detail below with reference to the accompanying drawings. First, the basic concept of the present invention is briefly described.

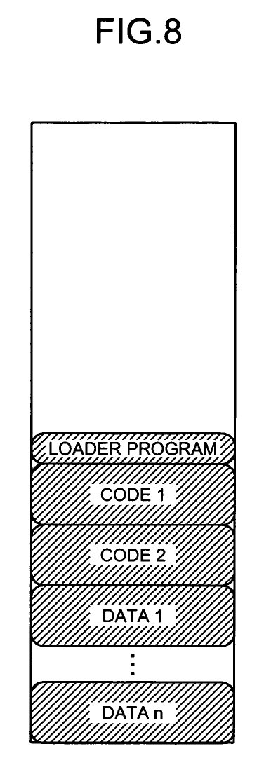

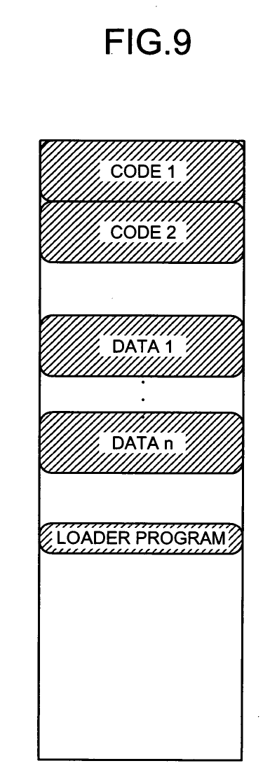

FIG. 8 is a schematic diagram of memory space before a conventional loader is executed, whereas FIG. 9 is a schematic diagram of the memory space after the loader is executed. As shown in the diagrams, the conventional loader transfers a program only to memory space of a processor that executes the loader.

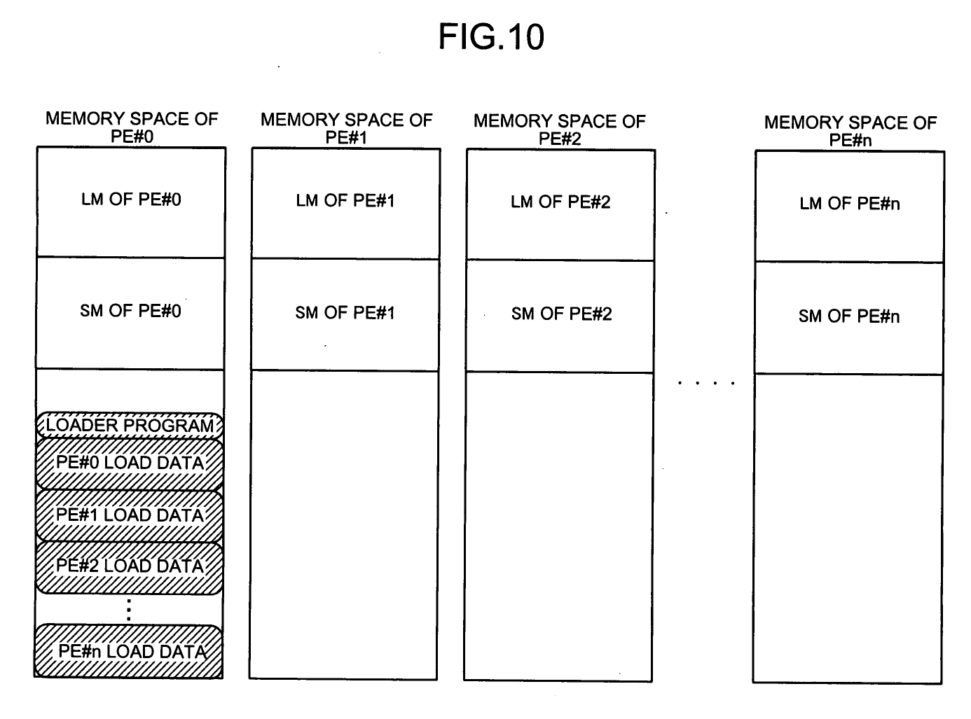

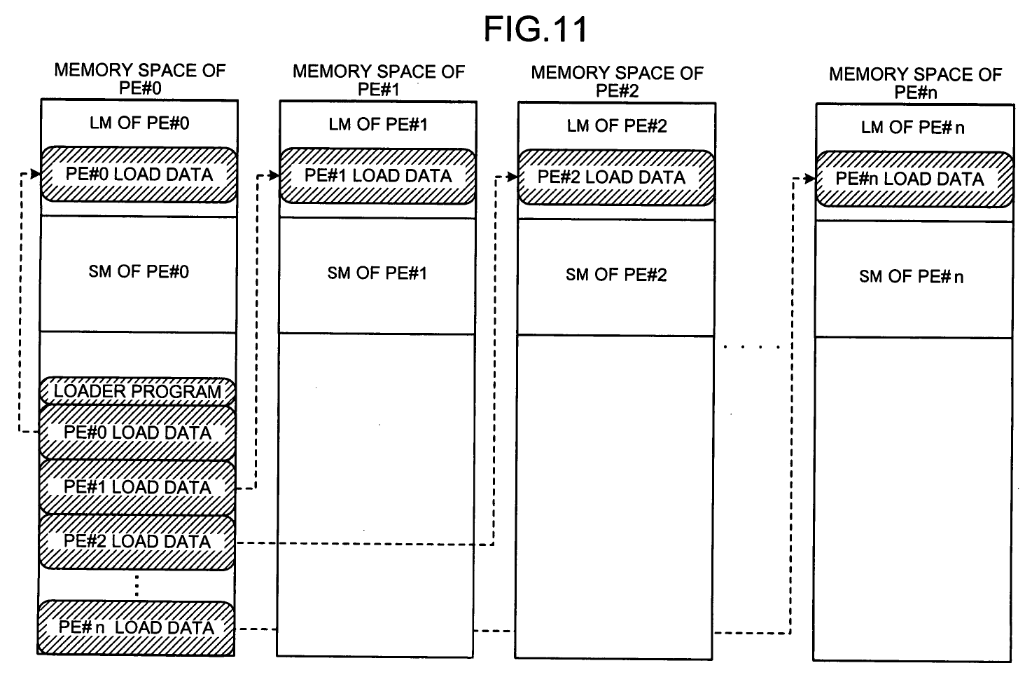

On the other hand, FIG. 10 is a schematic diagram of memory spaces before a loader according to the present invention is executed, whereas FIG. 11 is a schematic diagram of the memory spaces after the loader is executed. In the present invention, a master PE (for example, PE#0), which is any one of a plurality of PEs 400, executes a multi PE loader. The master PE transfers each of the load modules stored in a ROM 404 to the corresponding PEs 400. First to third embodiments described below relate to details of such a transferring procedure.

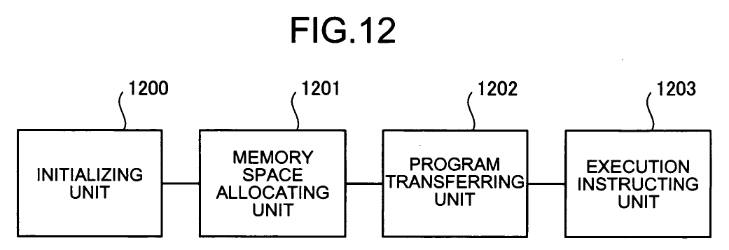

FIG. 12 is a functional block diagram of a computer system (particularly, a master PE thereof) according to the first embodiment of the present invention. Each functional unit shown in FIG. 12 is realized by the processor 401 of the master PE executing a multi PE loader in the memory 402 read out from the ROM 404.

An initializing unit 1200 performs initialization (such as zero-clearing a variable, or setting parameters) of the loader. A memory space allocating unit 1201 allocates the LM of each PE other than the master PE to the memory space of the master PE.

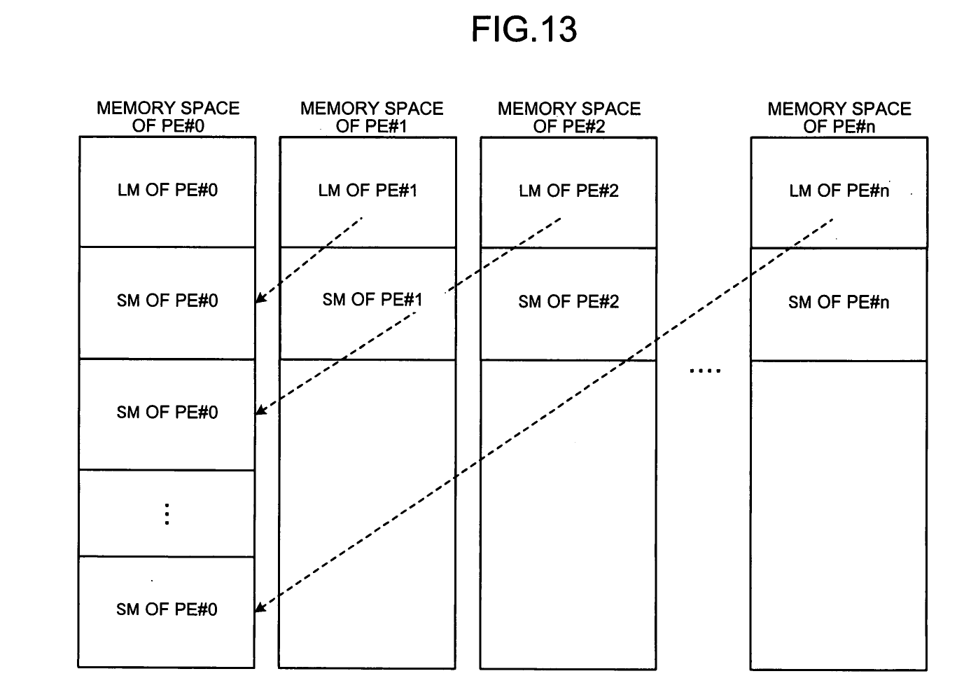

FIG. 13 is a schematic diagram for explaining the allocation of LMs of PE#1 to PE#n to the memory space of PE#0. In the first embodiment, the memory space allocating unit 1201 temporarily allocates the LMs of PE#1 to PE#n to a predetermined area of the memory space of PE#0 (the master PE), to which the SM of PE#0 is originally allocated. Thus, the LMs of PE#1 to PE#n can be exceptionally read and written by the PE#0 since they are temporally mapped to the memory space of PE#0 at the time of loading the MPMD program. It is assumed that the multi PE loader holds information required for setting registers of each PE and a bus.

A program transferring unit 1202 shown in FIG. 12 loads the MPMD program for each PE (each load module) into the memory 402 of each PE. That is, the program transferring unit 1202 transfers each MPMD program to the LM of PE#0 and the LMs of PE#1 to PE#n allocated to the memory space of PE#0 by the memory space allocating unit 1201.

An execution instructing unit 1203 instructs each PE to execute the MPMD program loaded into the memory 402 of each PE by the program transferring unit 1202.

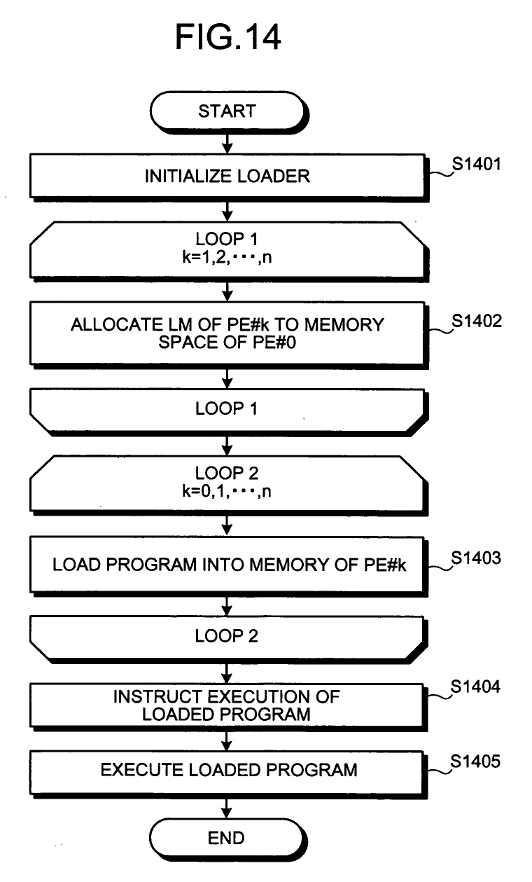

FIG. 14 is a flowchart of a program loading/executing process performed by the computer system.

In the PE#0 (the master PE) executing the multi PE loader, after initialization of the loader by the initializing unit 1200 (step S1401), the memory space allocating unit 1201 sequentially allocates the LMs of PE#1 to PE#n to the memory space of PE#0. That is, as shown in FIG. 13, the LM of PE#1, the LM of PE#2, . . . , and the LM of PE#n are allocated to different areas of the memory space of PE#0 (step S1402).

Furthermore, in the PE#0, the program transferring unit 1202 sequentially loads the MPMD program for each PE into the LM of each PE. That is, the program transferring unit 1202 loads an MPMD program for PE#0 into the area to which the LM of PE#0 has been allocated, an MPMD program for PE#1 into the area to which the LM of PE#1 has been allocated, . . . , and an MPMD program for PE#n into the area to which the LM of PE#n has been allocated (step S1403).

Then, in the PE#0, the execution instructing unit 1203 instructs the processors 401 of PE#1 to PE#n to execute the loaded program (step S1404). Thereafter, each PE receiving the instruction executes the loaded program (step S1405).

According to the first embodiment described above, the programs for the respective PEs stored in the ROM 404 can be distributed to the memories 402 of relevant PEs by the multi PE loader executed by the master PE.

In the first embodiment, however, the memory 402 of the master PE requires a capacity sufficient to allocate all the LMs of PE#1 to PE#n since they are allocated to different areas of the memory space of PE#0 respectively. In contrast, in the second embodiment described below, the same area is reused by the LMs of PE#1 to PE#n in turn to reduce a hardware capacity required for PE#0.

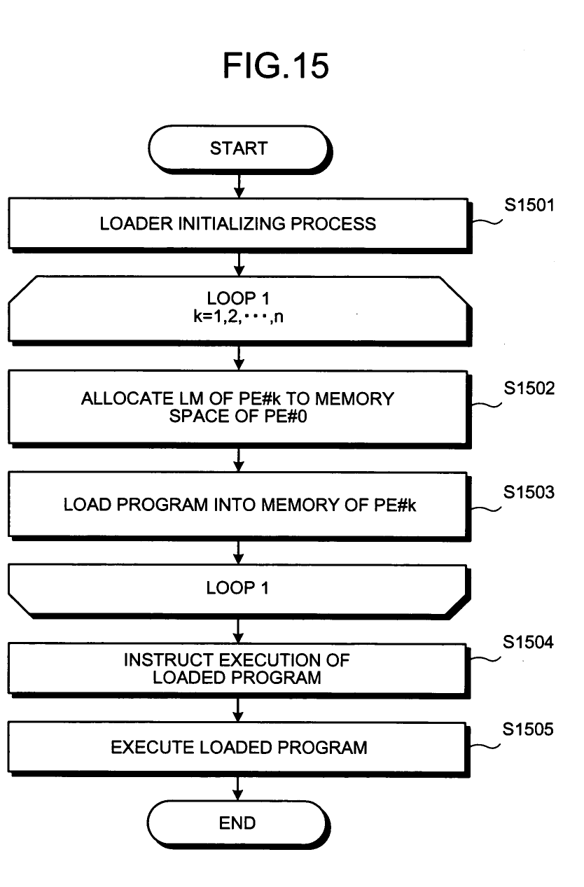

The functional structure of a computer system according to the second embodiment is similar to that according to the first embodiment shown in FIG. 14. FIG. 15 is a flowchart of a program loading/executing process performed by the computer system.

In the PE#0 (the master PE) executing the multi PE loader, after initialization of the loader by the initializing unit 1200 (step S1501), the memory space allocating unit 1201 allocates the LM of PE#k to the memory space of PE#0 (step S1502). The program transferring unit 1202 then loads an MPMD program for PE#k into the area to which the LM of PE#k is allocated (step S1503).

Then, after repeatedly performing the process at steps S1502 and S1503 on PEs with k from 1 to n, the execution instructing unit 1203 instructs the processors 401 of PE#1 to PE#n to execute the loaded program (step S1504). Thereafter, each PE receiving the instruction executes the loaded program (step S1505).

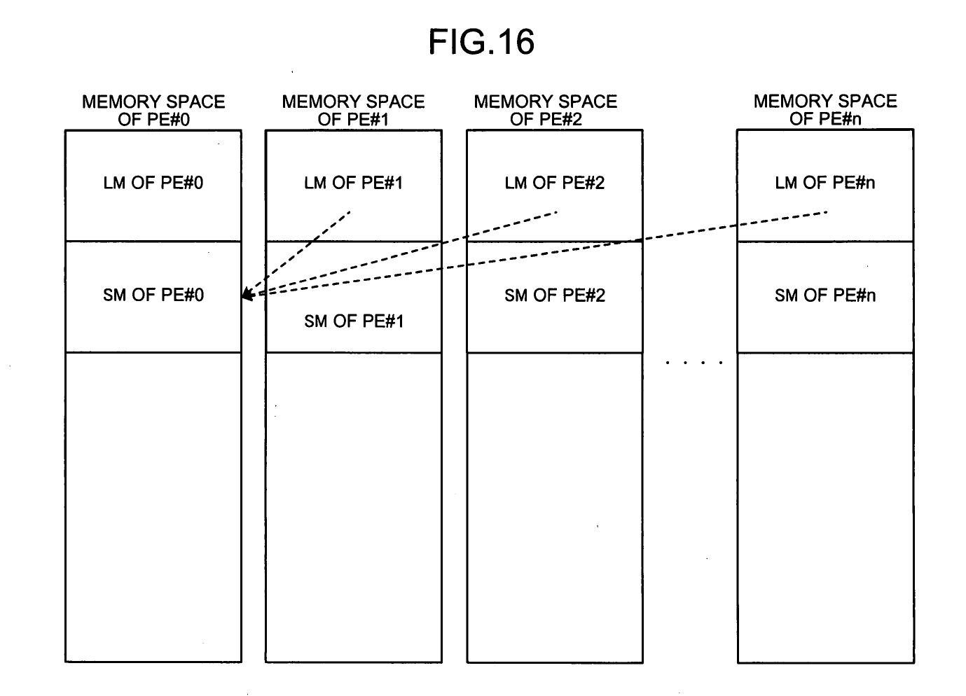

According to the second embodiment described above, the LMs of PE#1 to PE#n are allocated to the same area in the memory space of PE#0 as shown in FIG. 16. Therefore, the programs can be distributed to the relevant memories even if the memory capacity of the master PE is small.

In the first and second embodiments described above, the LMs of PE#1 to PE#n are allocated one by one to the memory space of PE#0. However, if the number of PEs is increased, an increase in overhead required for this mapping becomes not negligible. In contrast, in the third embodiment described below, programs are transferred by a DMA controller.

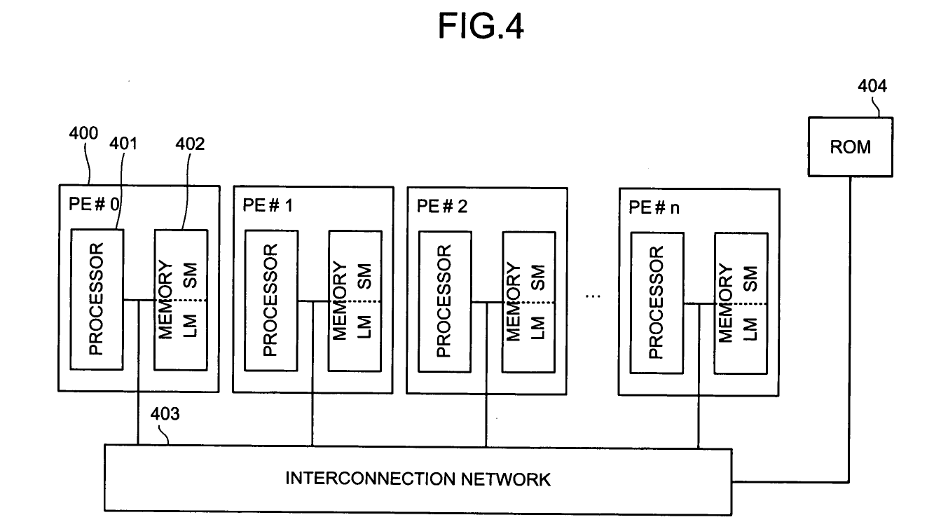

In the third embodiment, PE#0 (the master PE) includes a DMA controller for transferring the programs from PE#0 to PE#1 to PE#n, in addition to the hardware components shown in FIG. 4 (in other words, a PE including a DMA controller functions as the master controller).

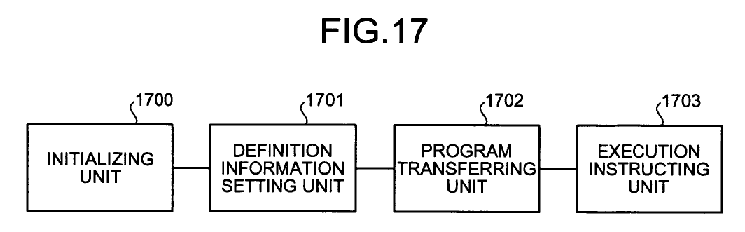

FIG. 17 is a functional diagram of a computer system (particularly, a master PE thereof) according to the third embodiment of the present invention. Functions of an initializing unit 1700 and an execution instructing unit 1703 are identical to those of the initializing unit 1200 and the execution instructing unit 1203 in the first and second embodiments.

A program transferring unit 1702 has an identical function to the program transferring unit 1202 in loading a program for each PE recorded on the ROM 404 into the memory 402 of each PE. However, the program transferring unit 1702 is realized not by the processor 401 but the DMA controller.

The computer system includes a definition information setting unit 1701, whereas it does not include a functional unit corresponding to the memory space allocating unit 1201 in the first and second embodiments.

The definition information setting unit 1701 sets definition information required for the program transferring unit 1702 (that is, the DMA controller) in a predetermined register. Specifically, the definition information includes the following three pieces of information: (1) a transfer destination (the ID of a transfer-destination PE and an address in that PE), (2) the size of a transfer area, and (3) a transfer source (the ID of a transfer-source PE and an address in that PE). It is assumed herein that these pieces of definition information are previously retained in the loader.

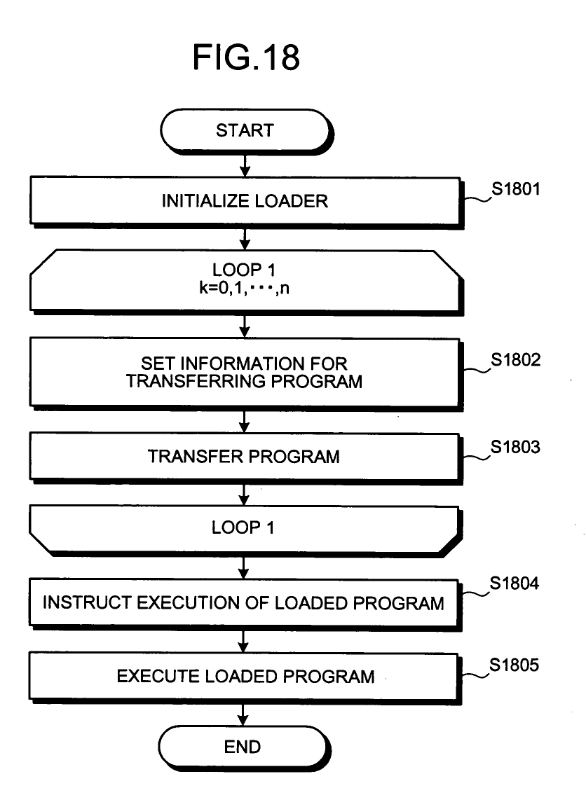

FIG. 18 is a flowchart of a program loading/executing process performed by the computer system.

In the PE#0 (the master PE) executing the multi PE loader, after initialization of the loader by the initializing unit 1700 (step S1801), the definition information setting unit 1701 sets definition information for transferring data from the ROM 404 to the memory 402 of PE#k (step S1802). Then, the program transferring unit 1702 loads the program into PE#k according to the information (step S1803).

Then, after repeatedly performing the process at steps S1802 and S1803 on PEs with k from 1 to n, the execution instructing unit 1703 instructs the processors 401 of PE#1 to PE#n to execute the loaded program (step S1804). Thereafter, each PE receiving the instruction executes the loaded program (step S1805).

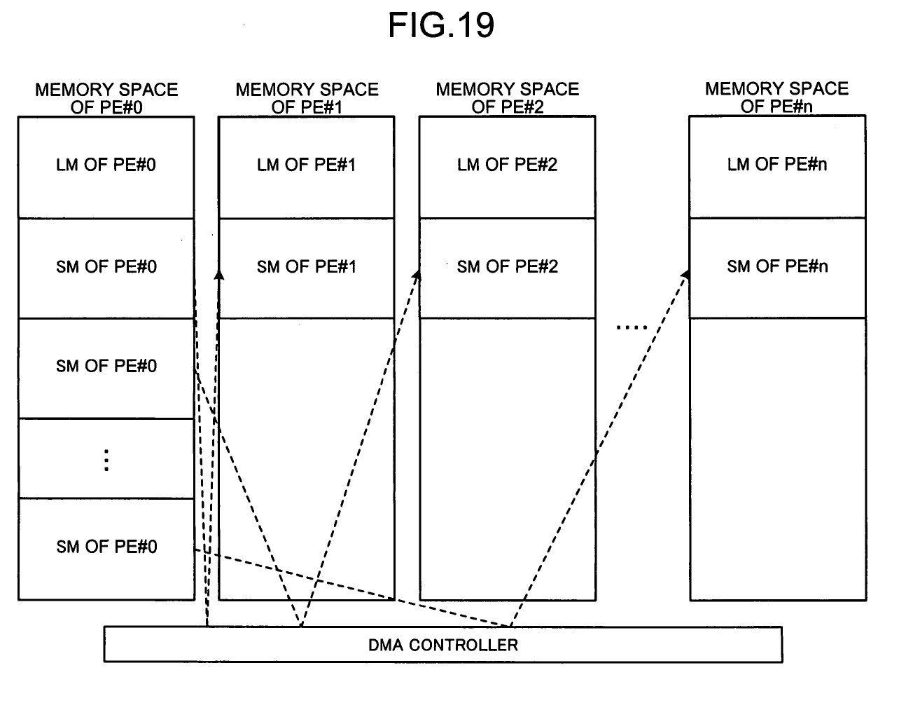

According to the third embodiment described above, as shown in FIG. 19, the programs are transferred by the DMA controller. Therefore, although the hardware cost is increased, the program can be loaded at a speed higher than that in the first and second embodiments

The program loading methods according to the first to third embodiments are realized by the processor 401 executing the multi PE loader stored in the ROM 404. Alternatively, this program can be recorded on various recording medium other than the ROM 404, such as an HD, FD, CD-ROM, MO, and DVD. The program can be distributed in the form of the recording medium or via a network, such as the Internet.

As described above, according to the present invention, even when each of the PEs is caused to execute each different program, the program for each PE is appropriately loaded to each PE under the control of the master PE, thereby allowing a load module of a MPMD program into a computer system adopting a distributed-shared-memory-type multiprocessor scheme.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method for loading a multiple processor multiple data (MPMD) program to a computer system, wherein the computer system includes a first processing element (PE) and a plurality of second PEs, and the first PE and the second PEs respectively include a memory, comprising:
allocating the memory of each second PE to memory space of the first PE; and
transferring the MPMD program from the memory of the first PE to the memory of each second PE that is allocated to the memory space.

2. The method according to claim 1, wherein the allocating includes allocating the memory of each second PE to different areas of the memory space respectively.

3. The method according to claim 1, wherein the allocating includes allocating the memory of a second PE to a predetermined area of the memory space to which the memory of another second PE has been allocated.

4. The method according to claim 1, further comprising setting information required for a DMA controller in the first PE to transfer the MPMD program to the memory of each second PE, wherein
the transferring includes the DMA controller transferring the MPMD program to the memory of each second PE based on the information.

5. A computer-readable recording medium that stores a loader program for loading a multiple processor multiple data (MPMD) program to a computer system, wherein the computer system includes a first processing element (PE) and a plurality of second PEs, the first PE and the second PEs respectively include a memory, and the loader program causes the computer system to execute:
allocating the memory of each second PE to memory space of the first PE;
transferring the MPMD program from the memory of the first PE to the memory of each second PE that is allocated to the memory space.

6. The computer-readable recording medium according to claim 5, wherein the allocating includes allocating the memory of each second PE to different areas of the memory space respectively.

7. The computer-readable recording medium according to claim 5, wherein the allocating includes allocating the memory of a second PE to a predetermined area of the memory space to which the memory of another second PE has been allocated.

8. The computer readable recording medium according to claim 5, wherein the loader program further causes the computer system to execute setting information required for a DMA controller in the first PE to transfer the MPMD program to the memory of each second PE.

9. A computer system that includes a first processing element (PE) and a plurality of second PEs, wherein the first PE and the second PEs respectively include a memory, and the first PE includes
an allocating unit that allocates the memory of each second PE to memory space of the first PE; and
a transferring unit that transfers the MPMD program to the memory of each second PE that is allocated to the memory space.

10. The computer system according to claim 9, wherein the allocating unit allocates the memory of each second PE to different areas of the memory space respectively.

11. The computer system according to claim 9, wherein the allocating unit allocates the memory of a second PE to a predetermined area of the memory space to which the memory of another second PE has been allocated.

12. The computer system according to claim 9, wherein
the first PE further includes a setting unit that sets information required for the transferring unit to transfer the multiprocessor program to the memory of each second PE, and the transferring unit, which is a DMA controller, transfers the MPMD program to the memory of each second PE based on the information.
